(19) United States
(12) Patent Application Publication
(10) Pub. No.: US 2010/0089180 A1
(43) Pub. Date: Apr. 15, 2010

(54) SAMPLING DEVICE AND METHOD AND SYSTEM FOR ITS USE

(75) Inventors: Allan L. Budd, Sun City West, AZ (US); Tom A. Baldwin, Reno, NV (US); John G. Watson, Reno, NV (US); Dale Lundgren, Gainesville, FL (US)

Correspondence Address: UNR/DRI Technology Transfer Office, UNR-DRI Technology Transfer Office, Mail Stop 321, Reno, NV, 89557, US

(73) Assignees: The Board of Regents of the Nevada System of Higher Education,; on Behalf of the Desert Research Institute

(21) Appl. No.: 12/419,963

(22) Filed: Apr. 7, 2009

Related U.S. Application Data
(60) Provisional application No. 61/043,367, filed on Apr. 8, 2008.
(60) Provisional application No. 61/090,496, filed on Aug. 20, 2008.

(51) Int. Cl. G01N 1/22

(52) U.S. Cl. 73/863.11

(57) ABSTRACT

Various embodiments of the present disclosure provide a sampling device, system, and method. The sampling device includes a sample inlet nozzle fluidly coupled to a dilution body. A carrier fluid delivery conduit is also fluidly coupled to the dilution body. In one implementation, the carrier fluid delivery conduit is coupled to a source of heated carrier fluid. Carrier fluid is delivered around a perforated portion of the sample inlet nozzle, in one configuration. In some cases, the sampling device includes a mixing device configured to produce laminar flow of carrier fluid about a fluid sample. In other cases, the mixing device produces turbulent flow of carrier fluid and fluid sample. Systems including the sampling device include, in some implementations, a sample separator, such as an inertial droplet separator. In further implementations, systems including the sampling device further include an atmospheric dispersion simulator.

### CROSS REFERENCE TO RELATED APPLICATION

This application claims the benefit of, and incorporates by reference, U.S. Provisional Patent Application No. 61/043,367, filed Apr. 8, 2008, and U.S. Provisional Patent Application No. 61/090,496, filed Aug. 20, 2008.

### FIELD

The present disclosure generally relates to sampling devices for obtaining fluid samples. In a specific example, the present disclosure provides a sampling device that continuously delivers sample to a detector.

### SUMMARY

In one embodiment, the present disclosure provides a sampling device. The sampling device is used, in one example, to transfer a sample from a sample source, such as an exhaust stack, to a detector. In another example, the sampling device is used to dilute a sample from a sample source, such as an exhaust stack, before the sample is measured by a detector.

The sampling device includes a sample inlet nozzle fluidly coupled to a dilution body. The dilution body is also fluidly coupled to a carrier fluid delivery conduit. In one example, the carrier fluid delivery conduit is coupled to a source of heated carrier fluid, such as at least substantially clean, heated air. In more particular implementations, the sampling device includes a carrier fluid heater coupled to the carrier fluid delivery conduit. Interacting heated carrier fluid with a fluid sample can evaporate liquid particles in the fluid sample or prevent or reduce condensation of condensable components in the fluid sample.

In one implementation, the sampling device includes a mixing device. In one example, the mixing device is fluidly coupled to a mixing chamber. The carrier fluid delivery conduit and sample inlet nozzle are fluidly coupled to the mixing chamber. The mixing device is located downstream from where carrier fluid from the carrier fluid delivery conduit is coupled to the mixing chamber and upstream from where the sample inlet nozzle is coupled to the mixing chamber.

In a specific configuration of the sampling device, the mixing device is configured to produce laminar flow of the carrier fluid radially around a fluid sample introduced through the sample inlet nozzle, such as a ring having a plurality of apertures formed in the axial surface of the ring. The sample inlet nozzle passes through a central opening of the ring and into the mixing chamber. In a more specific example of this configuration, the mixing chamber includes an aperture in its radial surface upstream from the mixing device. The aperture of the mixing chamber is fluidly coupled to the carrier fluid supply.

In another implementation, the sampling device includes a mixing device coupled to the carrier fluid delivery conduit and configured to supply carrier fluid upstream from where the fluid sample enters the dilution body through the sample inlet nozzle. In one example, the mixing device is a ring having a plurality of radial apertures formed in the surface of the ring. The sample inlet nozzle extends into the dilution body and delivers fluid sample upstream from carrier fluid from the mixing device. The interaction of the carrier fluid and fluid sample produces a turbulent flow. Turbulent flow can be useful in reducing deposition of material in the fluid sample on the sides of the dilution body.

In another implementation, the sample inlet nozzle extends into the dilution body and includes a perforated portion. In a particular example, the perforated portion is made of sintered metal. Carrier fluid is introduced around the perforated portion. In one example, carrier fluid from the carrier fluid delivery conduit is introduced upstream from the perforated portion. In another example, carrier fluid from the carrier fluid delivery conduit is introduced proximate the perforated portion of the sample inlet nozzle, such as through apertures in the sides of the dilution body. Passing the sample through the perforated portion of the sample inlet nozzle can help keep the sample centered in the dilution body and result in evaporation of liquid particles in the sample, or prevention or reduction of condensation of condensable components in the sample, at the point fluid sample leaves the perforated portion and enters the dilution body.

The present disclosure also provides a method of obtaining a sample. According to one embodiment, a fluid sample is passed through a sample inlet nozzle into a mixing chamber. A carrier fluid is introduced upstream from the mixing chamber. The carrier fluid is passed through a mixing device and intersects the sample. In a specific implementation of this method, the carrier fluid is heated before it enters the mixing chamber. In another particular implementation, passing the carrier fluid through a mixing device includes passing the carrier fluid through a series of radially spaced apertures on an axial surface of a ring. The mixing device, in some configurations, produces a laminar flow of carrier fluid about the fluid sample after the fluid sample exits the sample inlet nozzle.

In another embodiment, a fluid sample is passed through a sample inlet nozzle that extends into a dilution body, where the fluid sample then enters the dilution body. A carrier fluid is introduced into the dilution body upstream from the fluid sample. In a specific example, the carrier fluid is passed through a mixing device before interacting with the fluid sample, such as by passing the carrier fluid through a series of radially spaced apertures on the axial surface of a ring. In some implementations, the carrier fluid is heated. In a more particular example, the carrier fluid is passed through a heater prior to entering the dilution body. The interaction of the fluid sample and carrier fluid, in some implementations, provides turbulent flow of the combined fluid sample and carrier fluid streams. Turbulent flow can reduce deposition of material from the fluid sample on the sides of the dilution body.

According to yet another embodiment, a fluid sample is passed through a sample inlet nozzle that extends into a dilution body. Before exiting the sample inlet nozzle into the dilution body, the fluid sample is passed through a perforated portion of the sample inlet nozzle, such as a section of sintered metal, centering the flow of fluid sample in the dilution body. A carrier fluid is introduced into the dilution body proximate the perforated portion of the sample inlet nozzle. In particular examples, the carrier fluid enters the dilution body through apertures in the sides of the dilution body. In another implementation, the carrier fluid is first heated, such as by passing the carrier fluid through a heater. The heated carrier fluid evaporates liquid particles in the sample or prevents or reduces condensation of condensable components in the sample.

The present disclosure also provides a sampling system. The system includes a sampling device, such as one of the sampling devices described above. In some implementations, the system also includes an atmospheric dispersion simulation. In further implementations, the system includes a sample separator, such as an inertial droplet separator. In a particular example, the system includes an inertial droplet separator fluidly coupled to the sampling device. The sampling device is fluidly coupled to an atmospheric dispersion simulator.

In specific examples, the above-described sampling device, sampling system, and sampling method are used to measure effluent from industrial sources, such as smokestacks. In a more particular example, the device, system, and method are use to measure particulate matter in the effluent, such as PM_{2.5}. The present disclosure can allow for more accurate sample measurement by maintaining the sample in a form corresponding to the form it would achieve if released to the atmosphere, such as by diluting the sample, evaporating liquid components of the sample, or preventing or reducing condensation of condensable components in the sample.

There are additional features and advantages of the various embodiments of the present disclosure. They will become evident as this specification proceeds.

In this regard, it is to be understood that this is a brief summary of the various embodiments described herein. Any given embodiment of the present disclosure need not provide all features noted above, nor must it solve all problems or address all issues in the prior art noted above.

### BRIEF DESCRIPTION OF THE DRAWINGS

FIG. 1 is a perspective view of a sampling device according to an embodiment of the present disclosure.

FIG. 2 is a schematic diagram of a sampling device according to an embodiment of the present disclosure.

FIG. 3 is a schematic diagram of a sampling device according to an embodiment of the present disclosure.

FIG. 4 is a block diagram of components of a system for continuously sampling and monitoring particulate emissions from an emissions source using a disclosed sampling device.

FIG. 5 is a block diagram of components of a system for continuously sampling and monitoring particulate emissions from an emissions source using a disclosed sampling device and a disclosed inertial separator.

FIG. 6 is an exploded perspective view of an inertial separation device according to an embodiment of the present disclosure.

FIG. 7 is a perspective view of an inertial separation device according to an embodiment of the present disclosure.

FIG. 8 is a perspective view of an inertial separation device according to an embodiment of the present disclosure.

FIG. 9 is a side elevational view of an inertial separation device according to an embodiment of the present disclosure.

FIG. 10 is a side elevational view of an inertial separation device according to an embodiment of the present disclosure.

FIG. 11 is a side elevational cutaway view of the device of FIG. 10 along section A-A of FIG. 10.

FIG. 12 is a perspective view of an expansion chamber and sample outlet of an embodiment of an inertial separation device according to an embodiment of the present disclosure.

FIG. 13 is a top plan view of an expansion chamber and sample outlet of an embodiment of an inertial separation device according to an embodiment of the present disclosure.

FIG. 14 is a side elevational view of an expansion chamber and sample outlet of an embodiment of an inertial separation device according to an embodiment of the present disclosure.

FIG. 15 is a side elevational cutaway view of the device of FIG. 14 along section A-A of FIG. 14.

FIG. 16 is a perspective view of an inlet nozzle useable with an inertial separation device according to an embodiment of the present disclosure.

FIG. 17 is a top plan view of an inlet nozzle useable with an inertial separation device according to an embodiment of the present disclosure.

FIG. 18 is a side elevational view of an inlet nozzle useable with an inertial separation device according to an embodiment of the present disclosure.

FIG. 19 is a side elevational cutaway view of the device of FIG. 18 along section A-A of FIG. 18.

FIG. 20 is a perspective view of a cap useable with an inertial separation device according to an embodiment of the present disclosure.

FIG. 21 is a top plan view of a cap useable with an inertial separation device according to an embodiment of the present disclosure.

FIG. 22 is a side elevational view of a cap useable with an inertial separation device according to an embodiment of the present disclosure.

FIG. 23 is a side elevational cutaway view of the device of FIG. 22 along section A-A of FIG. 22.

### DETAILED DESCRIPTION

Unless otherwise explained, all technical and scientific terms used herein have the same meaning as commonly understood by one of ordinary skill in the art to which this disclosure belongs. In case of conflict, the present specification, including explanations of terms, will control. The singular terms “a,” “an,” and “the” include plural referents unless context clearly indicates otherwise. Similarly, the word “or” is intended to include “and” unless the context clearly indicates otherwise. The term “comprising” means “including;” hence, “comprising A or B” means including A or B, as well as A and B together.

As used herein, “ambient dispersion simulator,” or “atmospheric dispersion simulator,” refers to an apparatus, or component thereof, for conditioning a sample from an emissions source to produce a conditioned sample. The conditioned sample, for certain embodiments, is similar to an aerosol produced by the interaction of a plume from the emissions source with the atmosphere, such as an apparatus or component that simulates processes such as agglomeration, coagulation, condensation, adsorption, and nucleation that occur when the emissions plume interacts with the atmosphere. In a particular embodiment, the atmospheric dispersion simulator operates by diluting and reducing the temperature of a sample from the emissions source. In one example, the ambient dispersion simulator is a tank suitably dimensioned and having a suitable flow rate therethrough that provides for adequate dilution and cooling. Details of suitable ambient dispersion simulators are disclosed in U.S. patent application Ser. No. 11/361,532, incorporated by reference herein to the extent not inconsistent with the present disclosure.

As used herein, “continuously monitor” or “continuously sample” refer to a method of detection or sampling capable of making a plurality of discrete, real-time, measurements without intervention by a user. The term “continuously” does not exclude methods or devices that require occasional user intervention, such as replacement of sample media. Continuous monitoring is in contrast to manual sampling methods where user intervention is required between each distinct measurement, such as removal of sample media for analysis or changing sample media between each discrete measurement.

“Carrier fluid” refers to a gas or liquid that is used to transport a sample. The carrier fluid is typically inert or does not interfere with detecting an analyte of interest in the sample. When the carrier fluid is a gas, and the analyte of interest is particulate matter, suitable carrier fluids include air, carbon dioxide, and inert gasses, such as nitrogen, helium, and argon. In some examples, the carrier fluid is also a diluent. In such examples, the carrier fluid may be used to dilute a sample to a desired concentration prior to further treatment or detection.

Prior to use, the carrier fluid may be treated, such as to remove all or a portion of particulate matter in the carrier fluid. For example, the carrier fluid may be passed through one or more filters, such as HEPA or activated carbon filters, to remove particulates and gasses. The carrier fluid may also be dried.

Although methods and materials similar or equivalent to those described herein can be used in the practice or testing of the present disclosure, suitable methods and materials are described herein. The disclosed materials, methods, and examples are illustrative only and not intended to be limiting.

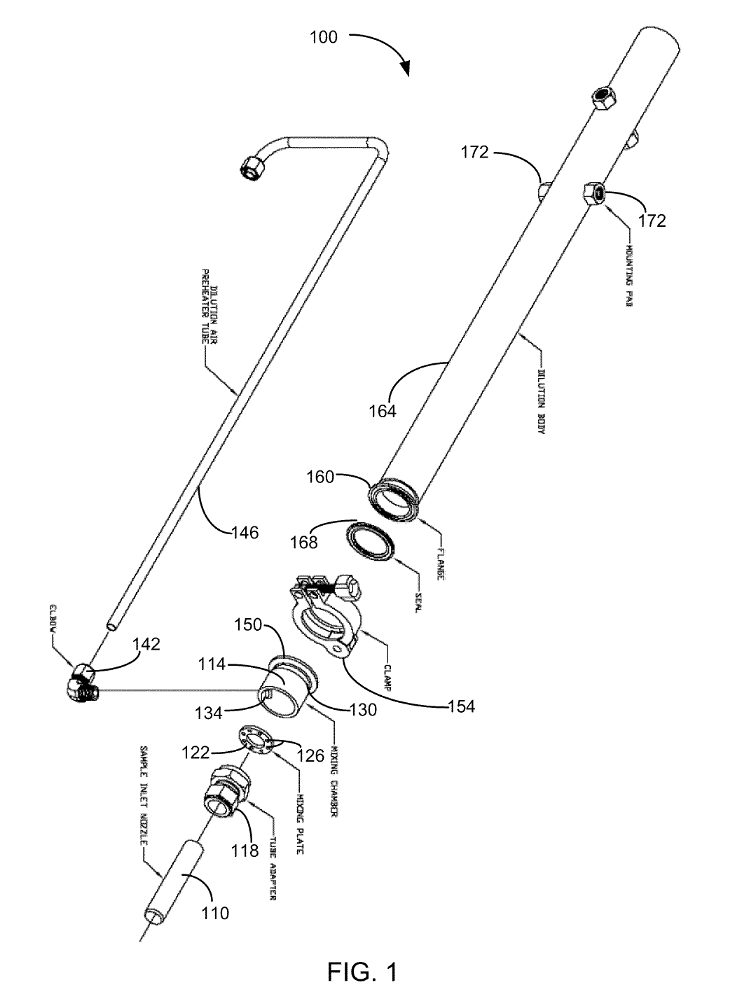

FIG. 1 is a schematic diagram of a sampling device 100 according to an aspect of the present disclosure. The sampling device 100 includes a cylindrical sample inlet nozzle 110 having a diameter sized to obtain a desired sample volume or obtain sample at a desired rate. In a specific example, the sample inlet nozzle is sized for isokinetic sampling. The sample size can depend on a number of factors, including the concentration of an analyte in the sample, the nature of the analyte, the type of detector used, or the sensitivity of the detector.

The sample inlet nozzle 110 is coupled to a cylindrical mixing chamber 114 using an adapter 118. The adapter 118 may be useful when the diameter of the mixing chamber 114 is different than the diameter of the sample inlet nozzle 110. The adapter 118, mixing chamber 114, and sample inlet nozzle 110 can be coupled using any suitable means. For example, the adapter 118, mixing chamber 114, and sample inlet nozzle may have mating threads. Such an arrangement can facilitate assembly, disassembly, or maintenance of the sampling device 100. In another form, the components 110, 114, 118 are connected in another manner, such as being welded or otherwise adhered together, connected by clamps or other fasteners, or held together by pressure or friction. Other types of coupling methods may be used, as well as combinations of coupling methods. In some implementations, the tube adapter 118 is omitted. For example, the sample inlet 110 and the mixing chamber 114 may be a unitary component.

The sample inlet nozzle 110 extends through the adapter 118 and into the mixing chamber 114 through a central aperture formed in a mixing plate 122. The mixing plate 122 has a plurality of radially disposed apertures 126 formed in the axial surface of the mixing plate 122. The mixing plate 122 is typically sized such that its diameter is substantially the same as the inner diameter of the mixing chamber 114, thus providing an engaging fit. The mixing chamber 114, in some examples, includes a portion 130 having a smaller diameter than the inner diameter of the mixing chamber 114 and serving as a collar against which the mixing plate 122 abuts.

In at least some examples, the mixing plate 122 is configured to produce laminar flow for fluids passing through the apertures 126. In some configurations of the sampling device 100, the mixing plate 122 is omitted and other configurations are used to produce such laminar flow. For example, fluid may be introduced in another manner behind the outlet of the sample inlet nozzle 110.

The mixing chamber 114 defines an aperture 134 formed in the radial surface of the mixing chamber 114. The aperture 134 is disposed upstream from the mixing plate 122. An elbow 142 couples the mixing chamber 114 and a carrier air preheater tube 146. The carrier air preheater tube 146 is coupled to a source of carrier air (not shown in FIG. 1). In at least some examples, the preheater tube 146 is thermally coupled to a heater (not shown) or has a heater integrally associated therewith.

The mixing chamber 114 further includes an outer collar 150. The outer collar 150 couples the mixing chamber 114 to a clamp 154. In turn, the clamp 154 is coupled to a flange 160 of a dilution body 164. A seal 168 is disposed between the flange 160 and the clamp 154. The seal 168 may also be coupled to the outer collar 150 of the mixing chamber 114. In another implementation, a separate seal is used to couple the outer collar 150 of the mixing chamber 114 and the clamp 154. The seal 168 is omitted in other implementations.

The dilution body 164 is a tube having mounting pads 172. The mounting pads 172, in one example, are threaded nuts attached to the radial surface of the dilution body 164, such as by welding.

The components of the device 100 may be constructed from any suitable material, which may be the same or different for the various components. Typical materials are selected to be at least substantially inert under the conditions with which they will be used, such as not producing material that might interfere with measurements obtained using the sampling device 100. In at least some examples, thermally insulating materials are used. In one configuration, one or more components of the device 100, particularly the dilution body 164 and preheater tube 146, include insulation, such as external insulation, to reduce heat loss. In specific examples, the components of the sampling device 100 are made from metals, such as steel or aluminum, or from plastics, such as poly(vinyl chloride).

The sampling device 100 may be constructed in a different manner than that shown in FIG. 1. For example, components shown separately may be integrated into unitary components. Similarly, components shown as unitary components may be broken down in multiple subcomponents and assembled to produce a component suitable for use in the sampling device 100. Although the components of the sampling device 100 are generally cylindrical, they also may be constructed in different geometric shapes, or combinations of such shapes, in other examples.

In operation, a vapor sample is obtained from the sample inlet nozzle 110. Carrier air enters the preheater tube 146 and is heated to a desired temperature before it is introduced into the mixing chamber 114. In the mixing chamber 114, the carrier air passes through the apertures 126 in the mixing plate 122. The apertures 126 disperse the carrier air in a laminar flow pattern.

After passing through the apertures 126 in the mixing plate 122, the carrier air mixes with the sample from the sample inlet nozzle 110. The sample and the carrier typically mix as they travel through the dilution body 164. In certain embodiments, heat from the preheated carrier is sufficient to evaporate liquid particles, such as water droplets, in the sample, which can yield more accurate data regarding condensable particulates in the sample. Heat may also be used to prevent particles from condensing during transport.

As a result of passing through the apertures 126 in the mixing plate 122, the carrier sweeps the walls of the dilution body 164, reducing wall deposition of liquid particles entrained in the sample. In at least some configurations, the sample is centered in the fluid stream exiting the dilution body 164. At least a portion of the fluid stream from the dilution body 164 passes into a detector (not shown). After passing through the dilution body 164, and optionally through a detector (not shown), the fluid stream from the dilution body 154 is, in one example returned to the sample source, such as an exhaust stack. In a specific application, the process can include either isokinetic or flow-proportioned, pre-dilution sampling of a condensable portion of the sample prior to analyzing the condensable portion of the sample with a fine particulate continuous monitor.

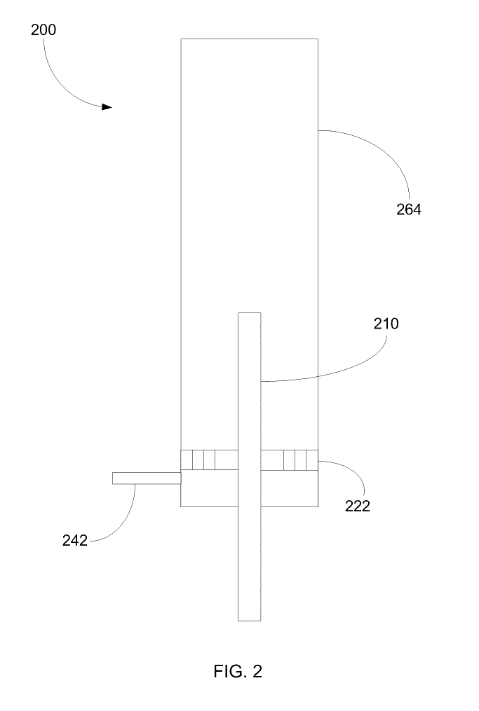

FIG. 2 presents another embodiment 200 of a sampling device according to the present disclosure. The sampling device 200 is generally constructed as described above for the sampling device 100 of FIG. 1, and similar components are correspondingly labeled. However, the sample inlet nozzle 210 extends further into the dilution body 264. Extending the sample inlet nozzle 210 in this way can allow for increased turbidity in the dilution body 264, rather than the laminar flow of sampling device 100. The increased turbidity can, in some implementations and for some applications, reduce deposition of sample material on the sides of the dilution body 264.

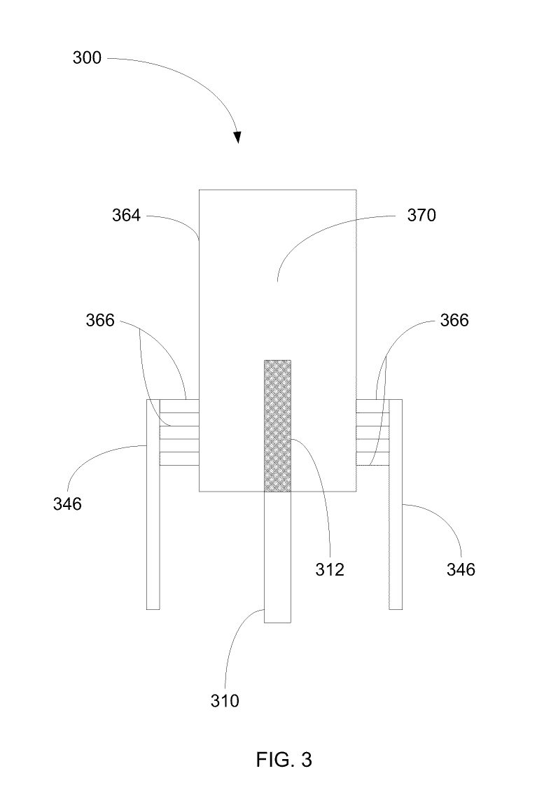

FIG. 3 presents yet another embodiment 300 of a sampling device according to the present disclosure. Again, the sampling device 300 is generally constructed as described above for the sampling device 100 of FIG. 1, and similar components are correspondingly labelled. In the sampling device 300, at least a portion 312 of the sample inlet nozzle 310 is formed from a perforated material. In a particular implementation, the portion 312 is formed from sintered metal, such as sintered steel. The dilution body 364 includes air inlets 366 into which air from the preheater tube 346 is directed. In some cases, the air inlets 366 are included in an addition to a mixing plate (not shown in FIG. 3). In other cases, the mixing plate is omitted, as shown in FIG. 3. The perforated portion 312 is in communication with an expansion area 370 of the dilution body 364. In some implementations, the expansion area 370 is separated from the portion of the dilution body 364 housing the air inlets 366 by a barrier.

The use of perforated portion 312 can have one or more benefits for some applications. For example, the perforated portion 312 centers sample air passing through the sample tube 310. Heated dilution air passing through the air inlets 366 can pass through the sintered portion 312, allowing droplets in the sample air to be evaporated. In some configurations, the operating parameters of the sampling device 300, as well as the construction parameters, are adjusted such that all or substantially all droplets in the sample air are evaporated by time the sample air passes from the sintered portion 312 into the expansion area 370.

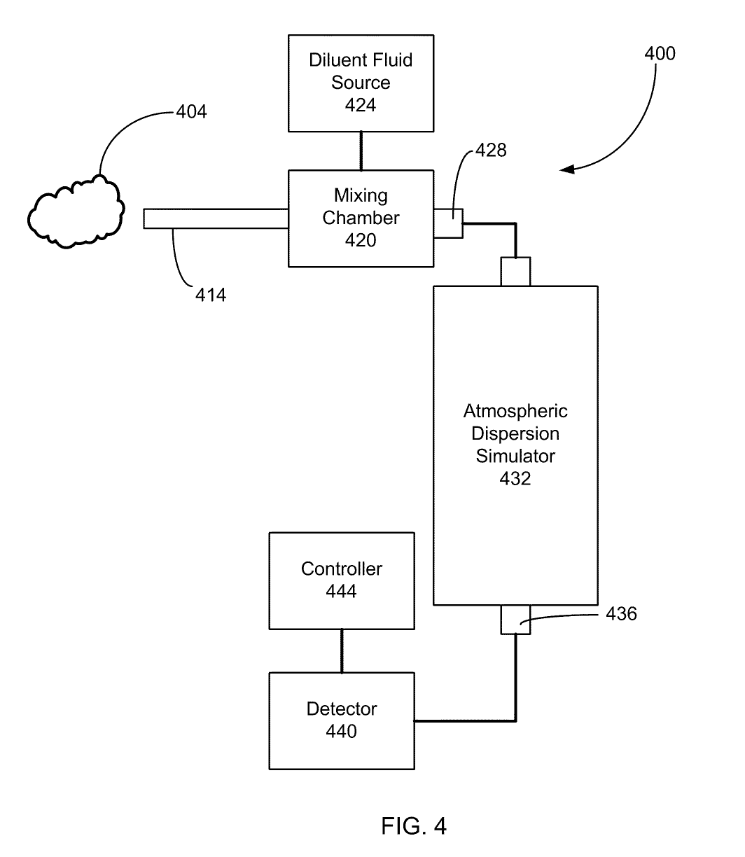

In one particular application, the sampling device 100 is used in combination with a monitoring system, or a component thereof, such as that disclosed in U.S. patent application Ser. No. 11/361,532, incorporated by reference herein to the extent not inconsistent with the present disclosure. FIG. 4 presents a block diagram of an example system 400 suitable for use with the sampling device 100.

A sample inlet 414 is placed proximate a gaseous sample 404, such as a sample 404 obtained from the sampling device 100 (FIG. 1), 200 (FIG. 2), or 300 (FIG. 3). The gaseous sample 404 is carried through the sample inlet 414 to a mixing chamber 420. The sample inlet 414, in particular implementations, is temperature controlled and can be heated to a desired temperature. The sample inlet 414 may be provided with various sensors (not shown), such as temperature sensors, pressure sensors, flow rate sensors, and moisture sensors. In particular embodiments, the sample inlet 414 includes an isokinetic sampling probe.

A diluting fluid source 424 is fluidly coupled to the mixing chamber 420. The diluting fluid source 424 may be a source of clean gas, such as air, or gas, such as CO₂ or N₂, that is substantially free from particulates. For example, ambient air may be passed through one or more filters, such as HEPA or activated carbon filters, to remove particulates and gasses. In a particular implementation, compressed or ambient air is dried by passing it through a recycling, heatless air drier. In certain embodiments, the diluting fluid source 424 or the mixing chamber 420 may be omitted.

The mixing chamber 420 has an outlet 428 in communication with an atmospheric dispersion simulator (ADS) 432. The ADS 432 has an outlet 436 in communication with a detector 440.

The detector 440 is configured to continuously monitor particles, such as particles of a particle size, or size range, in the gaseous sample 404. In particular embodiments, the detector 440 is configured to continuously monitor multiple particles sizes, or ranges of particle sizes. For example, the detector 440 may be configured to continuously measure PM_{2.5} and PM_{coarse} (which, in certain embodiments, is PM_{10-2.5}). The detector 440 may include multiple detection units, such as beta attenuation monitors, including dichotomous beta attenuation monitors, or tapered element oscillating microbalances. Alternatively, the detector 440 may be a single unit configured to separately detect different sizes of particles.

The detector 440 is in communication with a controller 444 that may be used for data collection, reporting. Or manipulation, as well as for controlling various components of the system 400.

In operation, the gaseous sample 404, such as a gaseous sample 404 from the sampling device 100, enters through the sample inlet 414 to the mixing chamber 420. In the mixing chamber 420, the sample 404 is mixed with a stream from the diluting source 424. After mixing, the diluted sample 404 exits the mixing chamber 420 through the outlet 428 and enters the ADS 432. In the ADS 432, the gaseous sample 404 undergoes one or more chemical or physical changes, such as agglomeration, coagulation, condensation, adsorption, or nucleation. The ADS 432 simulates, at least to a certain degree, the chemical or physical changes the gaseous sample 404 would undergo if released into the atmosphere.

The gaseous sample 404, conditioned by the ADS 432, passes through the outlet 436 into the detector 440. In particular implementations, the detector 440 continuously monitors particles of one or more sizes (or size ranges) in the gaseous sample 404. The detector 440 communicates data related to the gaseous sample 404 to the controller 444.

It should be understood that, in at least some embodiments, the system 400 does not require a diluting source 424. Similarly, the ADS 432 is not limited to an ADS which uses a diluted sample 404. Rather, such embodiments of the system 400 may employ an ADS using any suitable method of simulating the interaction of the sample 404 with the atmosphere.

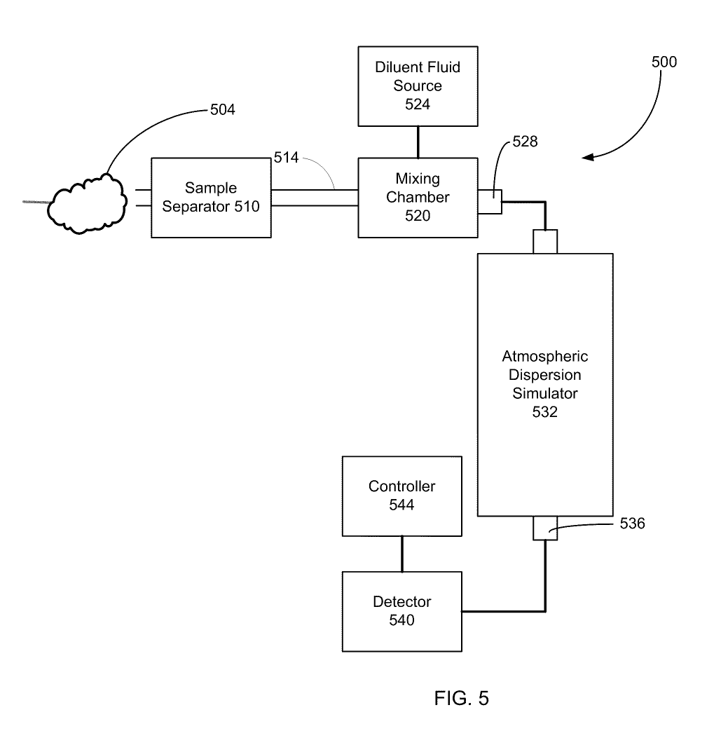

In another embodiment, shown in FIG. 5, the present disclosure provides a sampling system 500 that includes a dilution sampler and a sample separator. The system 500 is constructed generally as described for the system 400 of FIG. 4 and similar components are correspondingly labeled. The sample separator 510, which in one example is an inertial droplet separator (further described below), can be used to separate components of interest from a bulk sample. The desired components are transmitted to the sample inlet 514 and then processed as described above in conjunction with FIG. 5. The undesired portion of the sample is, in some implementations, returned to the sample source, such as a stack.

Inertial droplet separators used with the disclosed sampling devices (FIGS. 1-3) can allow sampling effluent from “wet” emissions sources, such as in order to determine their content of fine particulate matter. For example, the present disclosure may allow wet stacks, such as those used in the power plant industry, to be sampled for fine particulate matter (PM). According to one definition, fine particulate matter is identified as those fractions 10 micron spherical diameter and less found in particle slip (the fraction remaining after a pollution control device to remove the fine particulate matter). Some regulatory bodies may regulate fossil fuel emissions from industrial sources for PM₁₀ to PM_{2.5} (coarse fraction) and PM_{2.5} and below (fine fraction). Adding these two fractions together yields total fine PM emitted less than 10 microns.

Traditional sampling methods typically cannot be used in wet stacks due to the corrosive nature of the emission and the inability of devices which fractionate fine PM to function in wet environments. For example, some sampling environments include liquid droplets present in saturated gas at temperatures exceeding about 100° F., about 125° F., about 150° F., about 175° F., about 200° F., about 212° F., or about 220° F.

Thus, in certain embodiments, the present disclosure can be used for primary sample acquisition of fine particulate material (fine PM) from a fossil fueled, power plant, exhaust gas emission, located after a wet scrubber/de-mister, the primary pollution control device.

In one embodiment, the disclosed separator for use with the sampling device acquires water droplets containing dissolved solids from the exhaust gases in addition to normal fine particulate matter not associated with the water droplets or dissolved within them. In another embodiment, the separator is configured to operate in high water vapor environments, such as those having up to about 25%, about 30%, about 35%, about 40%, about 45%, about 50%, about 55%, about 60%, about 65%, about 70%, or about 75% water vapor by volume, and fractionate water droplets in the range of about 20 microns equivalent sphere and below.

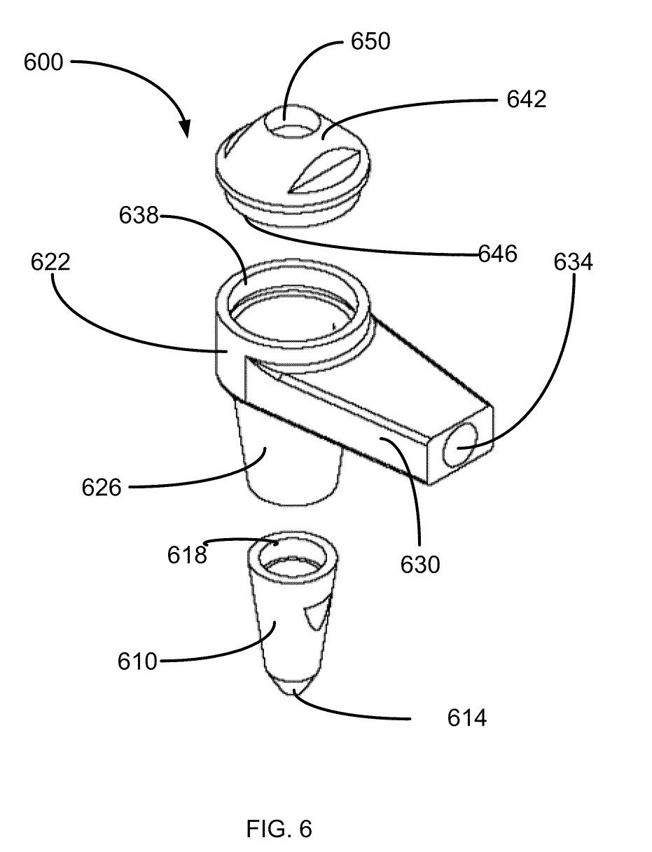

FIG. 6 illustrates one embodiment of an inertial separation device 600. In some examples, the inertial separation device 600 functions primarily to fractionate a sample for further sampling or measurements, a known particulate size cut. The inertial separation device 600 includes a hollow inlet nozzle assembly 610.

The inlet nozzle assembly 610 is shown having a conical shape, but may have other shapes in other implementations. In a particular configuration, the inlet nozzle assembly 610 is a replaceable nozzle of various sizes. An opening 614 of the inlet nozzle assembly is typically selected to provide for isokinetic sampling of a source, such as a stack having stack gas of known velocity, temperature, and absolute pressure. In one example, the inlet diameter of the inlet nozzle assembly 610 is chosen from the EPA Reference Method 5 calculation for sizing a particulate sampling nozzle. In another example, a standard particulate nozzle is chosen for use in the inlet nozzle assembly 610 to sample the stack gas particulate at the same velocity as the stack gas flow to help provide a representative sample. In another example, the inlet nozzle assembly 610 is not designed for isokinetic sampling. For example, sampling less than isokinetically (sampling velocity matched to stack gas velocity) favors large particles, while sampling greater than isokinetically favors smaller particles.

The inertial separation device 600 differs from EPA accepted, button hook nozzles in that it has an expansion chamber 622 coupled to the inlet nozzle assembly 610, which may be used to separate water droplets inertially. In one example, a lower portion 626 of the expansion chamber 622 is coupled to the inlet nozzle assembly 610. In other example, another portion of the expansion chamber 622 is coupled to the inlet nozzle assembly 610.

The expansion chamber 622 may be coupled to the inlet nozzle assembly 610 by suitable means, such as by securing an inner threaded portion 618 of the inlet nozzle assembly 610 to an outer threaded portion (not shown in FIG. 6) of the expansion chamber 622. In other implementations, the inlet nozzle assembly 610 and expansion chamber 622 are secured together in another fashion, such as by welding, pressure fit, or clasps. Gaskets or other sealing devices may be placed between the inlet nozzle assembly 610 and the expansion chamber 622 in order to help maintain an appropriate seal. In yet further examples, the inlet nozzle assembly 610 and the expansion chamber 622 are of unitary construction.

The expansion chamber 622 is illustrated as having a conical shape. However, the expansion chamber 622 may have other geometric shapes in other configurations. In a specific example, the expansion chamber 622 provides a suitable level of expansion, such as a 7° expansion, to allow the sample to rapidly expand, causing the inertial effects of gas velocity to diminish in the expansion chamber 622. In further examples, the expansion chamber 622 is conical and has a cone angle of about 15°. A 15° cone angle provides a 25:1 reduction in sample velocity between where the sample enters the inlet nozzle assembly 610 and a sample port 630 for an initial sample velocity of about 20 m/s. The dimensions of the separation device 600, including its length and the cone angle, can be varied according to the needs of a particular application, including the initial sample velocity, physical space requirements, and the degree of velocity reduction needed or desired. Such optimizations may be empirically determined.

The expansion chamber 622 is coupled to the sample port 630. The sample port 630 includes a conduit 634 coupled to the expansion chamber 622. The conduit 634 is fluidly coupled to an aperture (not shown in FIG. 6) formed in the side of the expansion chamber 622. In other configurations, the expansion chamber 622 does not include a sample port aperture and the sample is removed in another manner, such as a conduit extending into a desired portion of the expansion chamber 622.

Although the sample port 630 is shown intersecting the expansion chamber 622 at a right angle, it may intersect the expansion chamber 622 at other angles in some implementations. Although one sample port 630 is shown, the inertial separation device 600 includes more than one sample port 630 in other embodiments.

An upper portion 638 of the expansion chamber 622 is coupled to a cap 642. The upper portion 638 may be coupled to the cap 642, such as lower portion 646 of the cap 642, by any suitable means, such as by threads, clasps, pressure or friction fit, welding, or adhesives. In other embodiments, the cap 642 and expansion chamber 622 are of unitary construction. The cap 642 includes an aperture 646. Although the aperture 646 is shown at the top of the cap 642, the aperture 646 is located elsewhere on the inertial separation device 600 in other implementations. In yet further implementations, the cap 642 is omitted. For example, the inertial separation device 600 may be open to the atmosphere or coupled to a conduit (not shown).

In operation, fluid from a sample source, such as air from a stack, having a liquid content enters the inertial separation device 600 through the inlet nozzle assembly 610. The fluid then enters the expansion chamber 622, which provides a suitable level of expansion to allow the fluid to rapidly expand, causing the inertial effects of fluid velocity to diminish in the expansion. The particulate fraction which have mass (typically greater than PM 5 micron), and subject to gravity, including the majority water droplet fraction, will change upward velocity. The inertial separation device 600, by its geometry and residence time, slows down the particle and water droplet fraction of interest to a velocity close to their settling velocity. In essence, the size fraction of interest hovers at the sample point (proximate the sample port 630), allowing a side stream sample to be drawn off from the expansion chamber 622 through the conduit 634 of the sample port 630. In a specific example, the sample is drawn off at right angles to the expansion chamber 622 with a sufficient sampling velocity to allow larger, micron size water droplets to make a right angle turn and be drawn into a heated sampling probe (not shown), typically at a velocity of about 5 liters per minute, for further downstream water droplet evaporation and aging. Suitable sampling probes include the sampling devices of FIGS. 1-3.

The cap 642 of the inertial separation device 600 is open at the top to allow the unwanted droplet fraction to exit the inertial separation device 600 along with the majority of the stack gas at whatever the resultant velocity is remaining after the cone expansion.

The operational parameters of the inertial separation device 600 are typically chosen based on a particular application or installation of the device. For example, the cone angle, sample flow rate through the device, and sampling rate from the device may be chosen such that particles of interest are conducted through the sample port 630.

In some cases, the parameters are set such that the separation device 600 selects droplets having a size that correlates to a particular size of dried matter within the droplet. That is, the droplet, which includes water and other condensable matter, may be larger than the solid matter within the sample that is desired to be measured. In some examples, the ratio of wet particle droplet size to dried particle size is about 4:1. Thus, a separation device 600 configured to select droplets having a mean cross sectional width of about 10 μm can be expected to provide solid particulate matter having a mean cross sectional width of about 2.5 μm. This can be significant because, for example, the droplets released into the atmosphere may be expected to form solid particles whose size depends on the amount of solid material contained in the droplet. Thus, the present disclosure provides for a method of measuring the precursors of particular pollution, for example. If PM_{2.5} is of interest, particles which will give rise to such particles can be sampled from an emission source using the separation device 600.

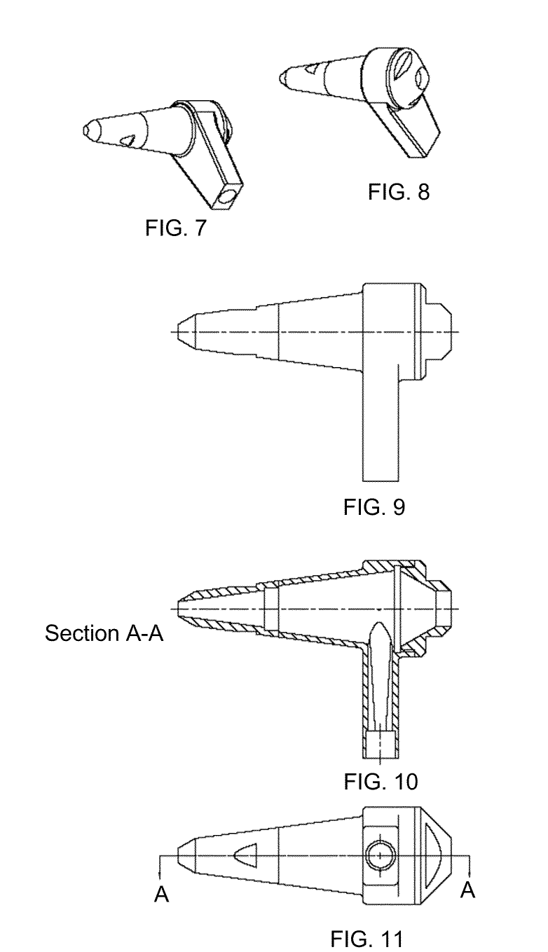

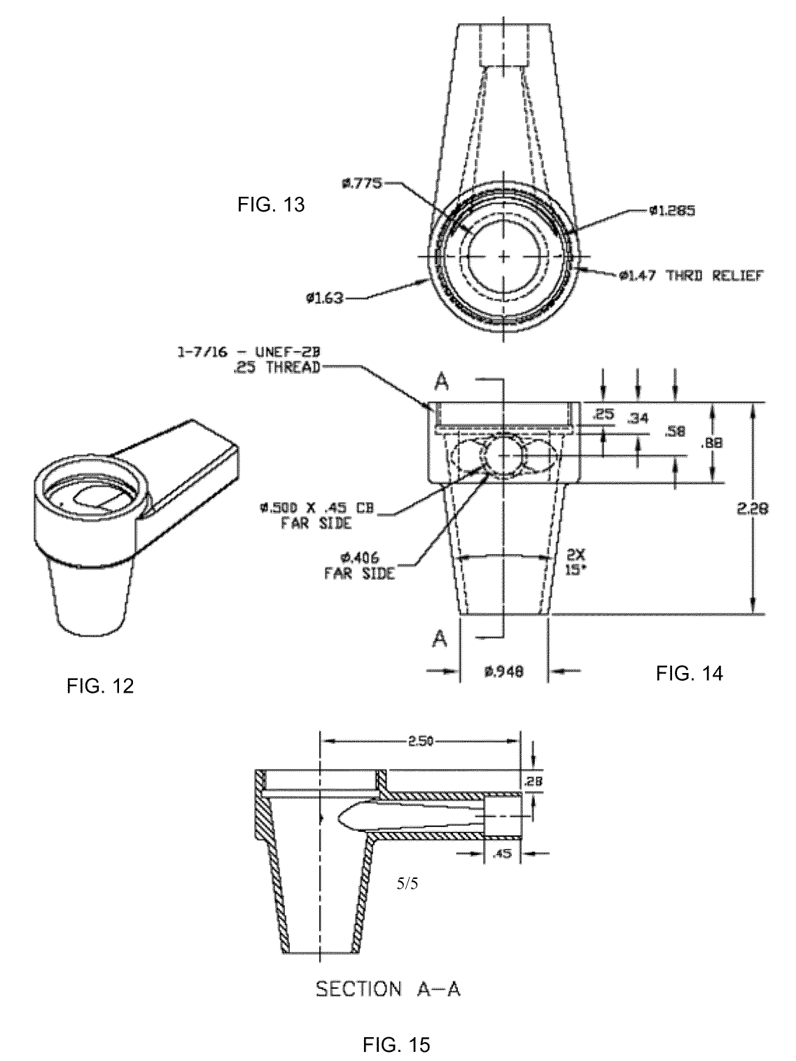

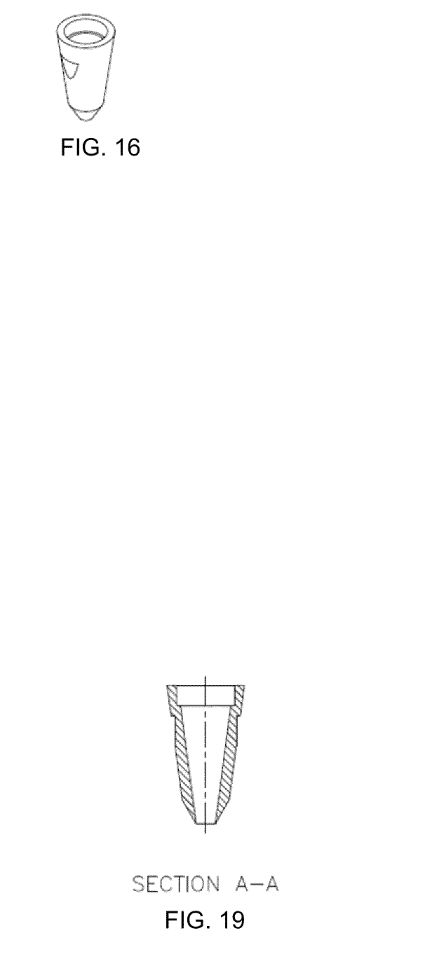

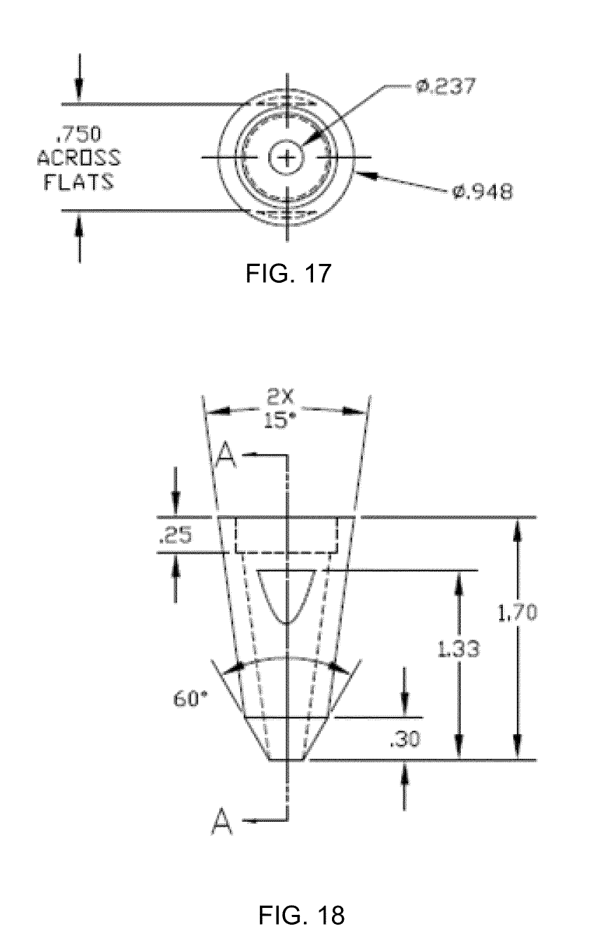

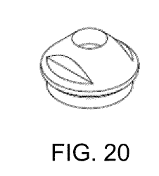

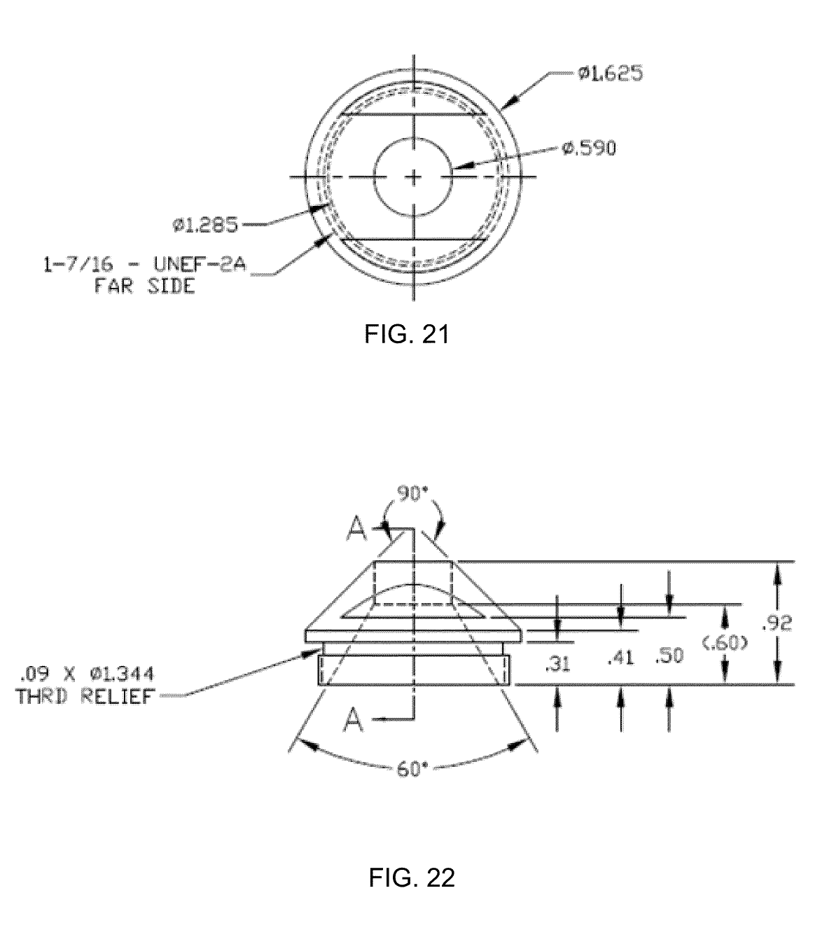

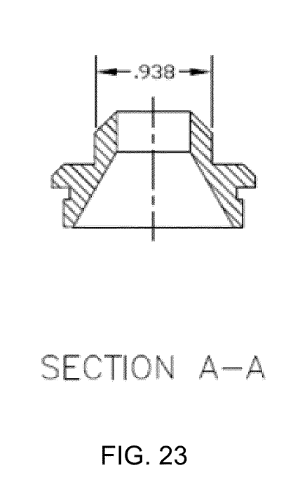

FIGS. 7-11 present alternate views of the inertial separation device 600 of FIG. 6. FIGS. 12-15 present additional views of the expansion chamber 622 and sample port 630 of the inertial separation device 600 of FIG. 6. FIGS. 16-19 provide additional views of an expansion chamber 622 that may be used in the inertial separation device 600 of FIG. 6. FIGS. 20-23 provide additional views of a cap 642 that may be used in the inertial separation device 600 of FIG. 6. Certain figures of FIGS. 16-23 include dimensions for a particular implementation of the inertial separation device 600. Such dimensions are provided as examples of suitable dimensions for that implementation, and are not intended to limit the scope of the present disclosure.

The disclosed sampling device, as well as embodiments of a system or method for its use, can provide a number of benefits. For example, the sampling device can allow a sample to be transported to a detection system without substantial alteration. For example, treating the sample with preheated air may vaporize liquid materials present in the sample, or keep materials from condensing in the sample, which may provide more accurate sample detection. Using a laminarly flowing carrier gas may reduce the interaction of the sample gas with the side of the transfer conduit, which can reduce sample material depositing on conduit walls. In at least certain implementations, the disclosed sampling device can be operating on a continuous basis. The disclosed sampling device can, in some cases, be easily added to existing sources to be monitored, such as to exhaust stacks.

It is to be understood that the above discussion provides a detailed description of various embodiments. The above descriptions will enable those of ordinary skill in the art to make and use the disclosed embodiments, and to make departures from the particular examples described above to provide embodiments of the methods and apparatuses constructed in accordance with the present disclosure. The embodiments are illustrative, and not intended to limit the scope of the present disclosure. The scope of the present disclosure is rather to be determined by the scope of the claims as issued and equivalents thereto.

We claim:

1. A sampling method, comprising:
introducing a fluid sample into a central axial portion of a conduit;
introducing a carrier fluid upstream from the fluid sample into a radial portion of the conduit, the carrier fluid and the fluid sample forming a diluted fluid sample stream;
passing the diluted fluid sample stream into a detector; and
detecting a component of the sample.

2. The sampling method of claim 1, further comprising, prior to introducing a carrier fluid upstream from the fluid sample, heating the carrier fluid.

3. The sampling method of claim 1, wherein introducing a fluid sample and introducing a carrier fluid are carried out continuously.

4. The sampling method of claim 1, further comprising passing the carrier fluid though a mixing device upstream from the fluid sample, wherein passing the carrier fluid through the mixing device causes the carrier fluid to flow laminarly along the radial surfaces of the conduit.

5. The sampling method of claim 1, wherein the fluid sample has a flow rate and the carrier fluid has a flow rate, the method furthering comprising controlling the fluid sample flow rate, the carrier fluid flow rate, or both to dilute the fluid sample to a predetermined concentration.

6. The sampling method of claim 1, wherein introducing a carrier fluid upstream from the fluid sample comprises introducing the carrier fluid through an aperture in a radial surface of the conduit.

7. The sampling method of claim 1, wherein the diluted fluid sample stream has a turbulent flow.

8. The sampling method of claim 1, wherein introducing a fluid sample into a central axial portion of a conduit comprises passing the fluid sample through a perforated sample conduit.

9. The sampling method of claim 1, further comprising vaporizing liquid particles in the fluid sample.

10. The sampling method of claim 9, wherein vaporizing liquid particles in the fluid sample is accomplished using heat from the carrier fluid.

11. The sampling method of claim 1, further comprising sweeping the walls of the conduit with the carrier fluid.

12. The sampling method of claim 1, further comprising passing the diluted fluid sample stream through an atmospheric dispersion simulator.

13. A sampling device, comprising:
a sample inlet configured to receive a fluid sample;
a dilution body fluidly coupled to the sample inlet;
a carrier fluid delivery conduit fluidly coupled to the dilution body upstream from the sample inlet; and
a mixing device operatively associated with the carrier fluid delivery conduit.

14. The sampling device of claim 13, wherein the mixing device comprises a ring defining a central opening and a plurality of apertures disposed circumferentially about the periphery of the axial surface of the ring.

15. The sampling device of claim 14, wherein the sample inlet penetrates the central opening of the ring, delivering sample fluid downstream from the ring.

16. The sampling device of claim 13, further comprising a heater thermally coupled to, or integrally associated with, the carrier fluid delivery conduit.

17. The sampling device of claim 13, wherein the sample inlet extends into the dilution body.

18. The sampling device of claim 13, wherein the mixing device is configured to produce laminar carrier fluid flow about a radial portion of a conduit such that the carrier fluid flows laminarly about the fluid sample through the dilution body

19. The sampling device of claim 13, further comprising an atmospheric dispersion simulator fluidly coupled to the dilution body.

20. A sampling system, comprising:
a sampling device comprising:
sample inlet configured to receive a fluid sample comprising liquid particles or condensable components;
a carrier fluid heater configured to heat carrier fluid;
a carrier fluid delivery conduit coupled to the carrier fluid heater and configured to convey heated carrier fluid;
a dilution body fluidly coupled to the sample inlet and the carrier fluid delivery conduit and configured to receive the heated carrier fluid and fluid sample; and
a mixing device operatively associated with the carrier fluid delivery conduit and configured to disperse the carrier fluid around the fluid sample in the dilution body, whereby heat from the heated carrier fluid evaporates liquid particles in the fluid sample or reduces condensation of condensable components in the fluid sample;
an inertial droplet separator fluidly coupled to the sample inlet; and
an atmospheric dispersion simulator fluidly coupled to the dilution body.
